(19) United States
(12) Patent Application Publication
(10) Pub. No.: US 2006/0229224 A1
(43) Pub. Date: Oct. 12, 2006

(54) Bleaching composition

(76) Inventor: Stephen Norman Batchelor, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/544,982

(22) PCT Filed: Feb. 2, 2004
(86) PCT No.: PCT/EP04/00960

§ 371 Date: Apr. 21, 2006

(30) Foreign Application Priority Data
Feb. 15, 2003 (GB) 0303521.9
Jun. 25, 2005 (GB) 0314808.7

(51) Int. Cl. C11D 3/00

(52) U.S. Cl. 510/367

(57) ABSTRACT

A photo bleaching composition is provided which comprises an aromatic 1,4 quinone.

The present invention relates to a photo-bleaching composition. The present invention also relates to a method of treating fabric using the photo-bleaching composition.

### BACKGROUND OF THE INVENTION

EP 0035470 discloses a textile treatment composition, which comprises a photo-bleaching component. The photo-bleach material has some effect against stains, but can also attack dye.

EP 1196521 discloses a fabric care system comprising a radical photo-initiator selected from hydrogen abstraction photo-initiators, bond cleavage radical photo-initiators or mixtures thereof is used to treat fabric, for example as a stain removal system in the washing or rinsing of fabric in a laundry process.

### SUMMARY OF THE INVENTION

The present invention accordingly provides a bleaching composition, comprising an aromatic 1,4 quinone. The aromatic quinone is regarded as a radical photo-initiator. The aromatic quinone surprisingly is a more weight effective photobleaching agent than other photo-initiators/photo-bleaches.

The present invention provides a bleaching composition, comprising an aromatic 1,4 quinone together with at least 1 wt % an ingredient selected from the group consisting of: fabric conditioning agent, and surfactant.

The remaining bulk of the bleaching composition comprises carriers and adjunct ingredients to 100 wt/wt % of the total bleaching composition. This bulk, in part or whole, may be selected from solvents, conditioners, builders, other bleach components, softening agents and other components as described herein.

It has also been found that the photo-bleach of the present invention has the advantage that they are stable in solution if kept in the dark. It is found that they do not degrade spontaneously on storage.

The photo-bleach systems according to the present invention are found to be soluble or dispersible in other media than water and can be used on dry-clean only garments.

The present invention extends to a commercial package comprising the aromatic quinone (photobleach) of the present invention together with instructions for its use in the treatment of a textile.

### DETAILED DESCRIPTION OF THE INVENTION

The following are exemplified non-limiting structures of suitable aromatic quinones that may used in the present invention:

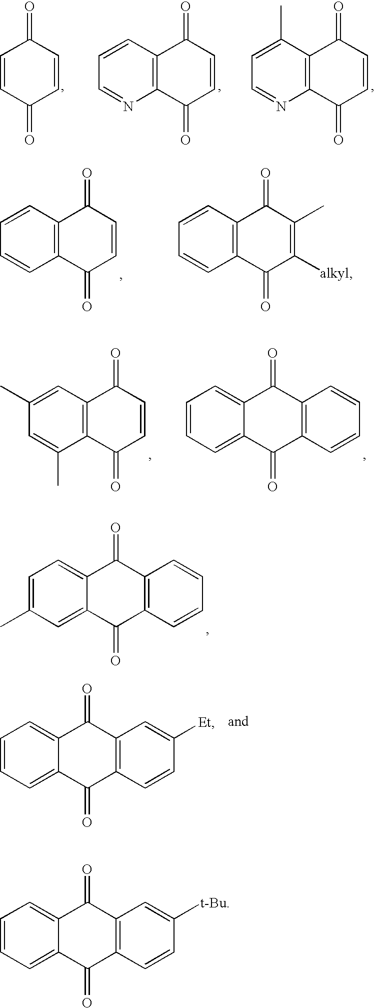

The aromatic quinone is part of a six membered conjugated ring. The aromatic quinone comprises two oxygen atoms that are 1,4 (e.g., as found in 1,4-naphthoquinone). In contrast to benzoquinone per se, it is preferred that the aromatic quinone moiety is further part of an extended conjugated pi system, such as found in naphthoquinones, and anthraquinones etc. It is preferred that the aromatic quinone comprises the core structure of napthoquinone, this encompasses anthraquinone.

The extended conjugated pi system may contain one or more heteroatoms as illustrated below.

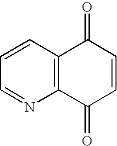

The aromatic quinones may be optionally substituted provided that the substituent does not result in rapid intramolecular quenching of the excited state of the aromatic quinone. The rate of intramolecular quenching is dependent on two factors the type of substituent and the position of the substituent with respect to the carbonyl groups of the quinone. With reference to the structures illustrated below, structure (a) is not suitable because of the propensity for intramolecular quenching; it is seen that the amine is three atoms remote from a carbonyl of the quinone. The quinone of structure (b) is suitable for use with the present invention because the carbonyl is four atoms remote from a carbonyl of the quinone.

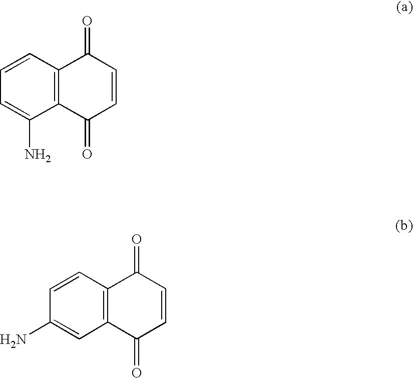

As one skilled in the art will appreciate not only an amine substituent would serve to quench the excited state of the quinone; examples of other such substituents to be avoided which are three atoms remote from a carbonyl of the quinone are: —OH, NR2, —NHR, wherein R is alkyl or aromatic. With regard to this intermolecular quenching, it is most preferred that the aromatic quinone used in the present invention has a half-life (t½) of greater than 100 ns in oxygen free benzene after irradiation. The half-life (t½) is the intrinsic quality of the aromatic quinone per se. Reference to half-life (t½) as described herein is as described above unless explicitly defined otherwise.

The following are suitable aromatic quinones that may used in the present invention: 1,4-naphthoquinone, 9,10-anthraquinone, 2-methyl-1,4-napthoquinone (vitamin K3) which is widely used in chicken feed [the holistic approach to chicken nutrition and stain removal]. The preferred aromatic quinones are those based upon vitamin K3 or metabolites thereof. Vitamin K3 is particularly preferred because we have surprisingly found that vitamin K3 is classified as not photo-toxic according to the protocol as found in Annex II “B.41. Photo-toxicity-In Vitro 3T3 NRU Photo-toxicity Test” of the Commission Directive 2000/33/EC of 25 Apr. 2000 as published in Official Journal of the European Communities EN. L 136/98 8.6.2000.

The photo-bleach suitably undergoes one of the reactions set out above when excited by radiation falling generally in the range 2900-800 nm. For example, natural sunlight, which comprises light in this region, will be suitable for causing the photo-bleach to undergo one of the reactions described above. Preferably, the photo-bleach has a maximum extinction coefficient in the ultraviolet range (290-400 nm) which is greater than 100 mol⁻¹ lcm⁻¹. Suitably, the photo-bleach is a solid or a liquid at room temperature.

Preferably, the photo-bleach is substantially colourless and gives non-coloured photoproducts upon irradiation.

The present inventors have found that photo-bleaches having a specified hydrophobicity, measured by their log P value, have a particularly preferred effect. All materials for the removal of stains also have a tendency to attack dye. The preferred photo-bleach systems have a particularly beneficial balance of stain removal versus dye attack tendency.

Preferably, the photo-bleach has a high log P value, where log P is the octanol-water partition coefficient. It is preferred that the photo-bleach has a log P measured at 25° C. in excess of 2.5 and more preferably in excess of 4.0.

The Log P value may be changed by varying pendant groups of the aromatic quinone.

Fabric Care/Fabric Wash Bleaching Compositions

The present invention is suitable for use in industrial or domestic fabric wash compositions, fabric conditioning compositions and compositions for both washing and conditioning fabrics (so-called through the wash conditioner compositions). The present invention can also be applied to industrial or domestic non-detergent based fabric care compositions, for example spray-on compositions.

Fabric wash compositions according to the present invention may be in any suitable form, for example powdered, tableted powders, liquid or solid detergent bars.

Fabric wash compositions according to the present invention comprise a fabric wash detergent material selected from non-soap anionic surfactant, nonionic surfactants, soap, amphoteric surfactants, zwitterionic surfactants and mixtures thereof.

Suitable anionic surfactants are well known to the person skilled in the art and include alkyl benzene sulphonate, primary and secondary alkyl sulphates, particularly C₈-C₁₅ primary alkyl sulphates; alkyl ether sulphates; olefin sulphonates; alkyl xylene sulphonates, dialkyl sulphosuccinates; ether carboxylates; isethionates; sarcosinates; fatty acid ester sulphonates and mixtures thereof. The sodium salts are generally preferred. Nonionic surfactants are also well known to the person skilled in the art and include primary and secondary alcohol ethoxylates, especially C₈-C₂₀ aliphatic alcohol ethoxylated with an average of from 1 to 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkyl polyglycosides, glycerol monoethers and polyhydroxy amides (glucamide). Mixtures of nonionic surfactant may be used.

Detergent compositions suitable for use in domestic or industrial automatic fabric washing machines generally contain anionic non-soap surfactant or nonionic surfactant, or combinations of the two in suitable ratio, as will be known to the person skilled in the art, optionally together with soap.

Many suitable detergent-active compounds are available and fully described in the literature, for example in “Surface-Active Agents and Detergents”, Volumes I and II, by Schwartz, Perry & Berch.

Anionic surfactant is suitably present at a level of from 5 wt % to 50 wt %, preferably 10 wt %-40 wt % based on the fabric treatment composition. Nonionic surfactant is suitably present at a level of 1 to 20 wt %, preferably 5 to 15 wt %.

The total amount of surfactant present in the bleaching composition will depend upon the intended end use and may be as high as 60 wt % for example in a composition for washing fabrics by hand. In this regard it is preferred that the bleaching composition comprises between 2 to 60 is wt % of a surfactant, preferably 5 to 40 wt %. The surfactant has an HLB (hydrophilic/lipophilic balance) greater that 10, more preferably greater than 15. For a discussion of HLB the reader is directed to and article by Griffin, W. C. in J. Soc. Cosmetic Chemists Vol. 1 page 311, 1945 and Davies, J. T. and Rideal, E. K. in Interfacial Phenomena, Acad. Press, NY, 1961, pages 371 to 382. The HLB value requirement reflects the importance of the rate of solubility and dispersibility of the surfactant present from the bleaching composition to the aqueous wash medium inconjunction with surface activity towards the substrate being washed.

Detergency Builder

The detergent compositions of the invention will generally also contain one or more detergency builders as described in EP 1196521. Sodium carbonate is preferred as a builder. The total amount of detergency builder in the compositions will be suitably in the range from 5 to 80 wt %, preferably from 10 to 60 wt %.

Other Bleach Components

Detergent compositions according to the invention may also suitably contain a peroxy bleach system for example, inorganic persalts or organic peroxyacids, capable of yielding hydrogen peroxide in aqueous solution.

Suitable peroxy bleach compounds include organic peroxides such as urea peroxide, and inorganic persalts such as the alkali metal perborates, percarbonates, perphosphates, persilicates and persulphates. Preferred inorganic persalts are sodium perborate monohydrate and tetrahydrate, and sodium percarbonate.

Preferred is sodium percarbonate having a protective coating against destabilisation by moisture. Most preferred is sodium percarbonate having a protective coating, for example comprising sodium metaborate and sodium silicate is disclosed in GB 2 123 044B (Kao).

Fabric Softening Composition

The fabric treatment composition of the present invention may be a fabric conditioning composition or it may comprise fabric conditioner.

The fabric softening compound is preferably a cationic nonionic or anionic fabric softening compound. It is preferred that the bleaching composition of the present invention when used as a fabric conditioning/softening bleaching composition comprises at least 5 % of fabric softening compound(s).

The fabric softening compound may be a quaternary ammonium material comprising a polar head group and one or two alkyl or alkenyl chains. The fabric softening compound may also be a nonionic fabric softening compound such as a fabric softening oil, a fabric softening silicone composition or a fabric softening ester composition such as sugar esters.

Particularly preferably, the fabric softening compound has two long chain alkyl or alkenyl chains with an average chain length greater than C₁₄, more preferably each chain has an average chain length greater than C₁₄, more preferably at least 50% of each long chain alkyl or alkenyl group has a chain length of C₁₈.

It is preferred if the long chain alkyl or alkenyl groups of the fabric softening compound are predominantly linear.

It is highly preferred if the fabric softening compounds are substantially water-insoluble. Substantially insoluble fabric softening compounds in the context of this invention are defined as fabric softening compounds having a solubility less than 1×10⁻³ wt % in demineralised water at 20° C., preferably the fabric softening compounds have a solubility less than 1×10⁻⁴, most preferably the fabric softening compounds have a solubility at 20° C. in demineralised water from 1×10⁻³ to 1×10⁻⁶.

Well known species of substantially water-insoluble quaternary ammonium compounds having the formula:

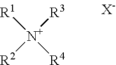

wherein R¹ and R² represent hydrocarbyl groups having from 12 to 24 carbon atoms; R³ and R⁴ represent hydrocarbyl groups containing 1 to 4 carbon atoms; and X is an anion, preferably selected from halide, methyl sulphate and ethyl sulphate groups are preferred.

Representative examples of these quaternary softeners include di(tallow alkyl) dimethyl ammonium methyl sulphate; dihexadecyl dimethyl ammonium chloride; di(hydrogenated tallow alkyl) dimethyl ammonium chloride; dioctadecyl dimethyl ammonium chloride; di(hydrogenated tallow alkyl) dimethyl ammonium methyl sulphate; dihexadecyl diethyl ammonium chloride; di(coconut alkyl) dimethyl ammonium chloride, ditallow alkyl dimethyl ammonium chloride and di(hydrogenated tallow alkyl) dimethyl ammonium chloride (Arquad 2HT Trade Mark).

Other preferred softeners contain esters or amide links, for example those available under the trade names Accosoft 580, Varisoft 222, and Stepantex.

Particularly preferred fabric softening compounds are water-insoluble quaternary ammonium materials which comprise a compound having two C₁₂₋₁₈ alkyl or alkenyl groups connected to the molecule via at least one ester link. It is more preferred if the quaternary ammonium material has two ester links present. The preferred ester-linked quaternary ammonium material for use in the invention can be represented by the formula:

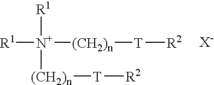

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups;

T is

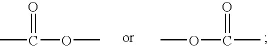

X⁻ is any suitable anion and n is an integer from 0-5. Particularly preferred is di(ethyl ester) dimethyl ammonium chloride (DEEDMAC).

A second preferred type of quaternary ammonium material can be represented by the formula:

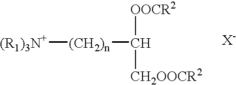

wherein R₁, n, X⁻ and R₂ are as defined above.

It is advantageous for environmental reasons if the quaternary ammonium material is biologically degradable.

Preferred materials of this class such as 1,2 bis[hardened tallowoyloxyl-3-trimethylammonium propane chloride and their methods of preparation are, for example, described in U.S. Pat. No. 4,137,180 (Lever Brothers). Preferably these materials comprise small amounts of the corresponding monoester as described in U.S. Pat. No. 4,137,180 for example 1-hardened tallowoyloxy-2-hydroxy trimethylammonium propane chloride.

The fabric softening agent may also be a polyol ester quat (PEQ) as described in EP 0 638 639 (Akzo).

Other Ingredients

The compositions of the invention can also contain one or more optional ingredients, selected from pH buffering agents, perfume carriers, fluorescers, colorants, hydrotropes, antifoaming agents, antiredeposition agents, enzymes, optical brightening agents, opacifiers, anti-shrinking agents, anti-wrinkle agents, anti-spotting agents, germicides, fungicides, anti-corrosion agents, drape imparting agents, antistatic agents and ironing aids.

The present invention may be in the form of a dilute or concentrated aqueous solution or suspension, for example as described in WO 97/15651, WO 95/27769. Alternatively, the composition may be in the form of a powder for use in the rinse cycle of an automatic washing machine. Alternatively, the composition may be in the form of a sheet comprising fabric conditioning compositions for use in a tumble dryer, for example as disclosed in WO 95/27777. Alternatively, the composition may be in the form of a substantially non-aqueous concentrate as described in international patent application no. PCT/EP99/00497.

The composition may also comprise a transition metal catalyst or precursor thereof, for example as described in PCT/GB99/02876 and PCT/EP01/13314.

The compositions according to the present invention may further include through the wash softening material, such as cationic fabric softener.

Non-Detergent-Based Fabric Care Products

The present invention can also be used in non-detergent-based fabric care products. For example, the product may comprise the stain removal system as the principal ingredient. For example, non-detergent based compositions may comprise solutions of the stain removal system of the present invention in a suitable solvent, such as isopropanol, alcohol etc. The compositions may comprise aerosol or spray-on compositions. They may be in the form of sticks, bars, dab-on compositions, for example absorbed into sponges for application to the surface etc.

Hair and Skin Bleaching

A bleaching composition comprising vitamin K3 is suitable for bleaching hair and skin and in this regard the present invention extents to such. The hair/skin bleaching composition comprises suitable adjutants and carriers as found in respective chapters of Harry's Cosmeticology, 8th edition, Edited by Dr Martin Rieger; ISBN: 0-82060372-4. The present invention extends to a method of treating hair and skin respectively with a vitamin K3 containing composition.

Other Applications

There is consumer concern with regard to chemical contact between consumer and the majority of chemical compounds. Irrespective of whether the concern is judged to be warranted or not, the perception by the consumer is of paramount concern to producers of products. It would be desirable to be able to allay consumer concern by providing products having more “consumer friendly” acceptable photo-initiators. In this regard, vitamin K3 may be used also as a photo-initiator for polymerisation of monomers for the production articles, in particular food packaging.

The photo-polymerisation may be carried out with a chain carrier, for example an amine synergist, to improve the polymerisation process. Particularly preferred are acrylated amine oligomers as they will be polymerised into the polymer matrix and hence cannot escape.

The present invention will be further described by way of example only with reference to the following examples.

### EXAMPLE 1

The following three photo-bleaches were selected for comparison 2,4, 6-trimethyl benzophenone, Esacure KIP-150, and 2-ethyl-anthraquinone. Esacure KIP-150 is alpha-hydroxy-ketone based bond cleavage initiator and is available from Lamberti Spa (Via Marsala, 38 21013 Gallarate VA Italy). The benzophenone is an example of a non-catalytic hydrogen abstractor photo-bleach in contrast to the aromatic quinones of the present invention.

Palm oil stained cloths (Brazilian) were prepared as follows. Palm oil 0.06 g was added deposited onto individual woven white cotton cloth samples weighing 1.2 g each. The cloth samples were allowed to age for 1 hour before being washed. Each wash consisted of four stained cloths, 200 ml of 40° C. water and 1 g of Persil Colour-washing powder (purchased in UK, zeolite based). The wash liquor was agitated for 20 minutes then the clothes rinsed in cold water, wrung and irradiated in a weatherometer for 18 minutes. The weatherometer is designed to simulate outside line drying and was set to give 42 W/m2 in the UVA&B.

The washes were duplicated but with the addition of 9 ppm of the photo-bleach to the wash solution, corresponding to 0.18% by weight on the powder formulation.

After the wash/irradiation procedure the staining of the clothes relative to clean white cloth was measured on a reflectometer and expressed as the deltaE value.

Esacure KIP150=oligo[2-hydroxy-2-methyl-1-[4-(1-methylvinyl)phenyl]propanone.

The results are presented in Table 1.

TABLE 1

| | Average deltaE |
|---|---|
| Control | 24.9 |
| 2,4,6-trimethylbenzophenone | 16.2 |
| Esacure KIP150 | 16.7 |
| 2-ethylanthraquinone | 2.5 |

In the absence of photo-bleach a strong coloured stain is observed on the cloth, as indicated by the high deltaE value. The three photo-bleach result in bleaching of the stain and reduce the deltaE value. The results show that 2-ethylanthraquinone provides a greater bleaching effect over the other photo-bleaches. It is evident from the results that the stain is essentially removed in the experiment where 2-ethylanthraquinone is employed as a photo-bleach.

### EXAMPLE 2

The following three photo-bleaches were selected for comparison Esacure KIP-150, Camphoroquinone (non-aromatic quinone), and 2-methyl-1,4-napthoquinone.

The same procedure as found Example 1 was used and the results presented in Table 2.

TABLE 2

| | Average deltaE |
|---|---|
| Control | 24.5 |
| Esacure KIP150 | 15.3 |
| Camphoroquinone | 23.5 |
| 2-methyl-1,4-napthoquinone | 2.9 |

The aromatic quinone provides greater photo-bleaching than the other photo bleaches.

### EXAMPLE 3

A 1.5 g sample of PEG-methacrylate was poured into a glass tube and sealed. A similar sample was prepared but with the addition of 0.15% of vitamin K3. The samples were place outside on a sunny morning in February 2003 facing the sun at an angle of 10 degrees to the earth in Port Sunlight, Wirral, UK. After 30 minutes the sample containing vitamin K3 had polymerised, as evidenced by the formation of a thick polymer film. A control mixture without vitamin K3 did not form a thick polymer film.

Photo-Toxicity Test

Photo-bleaches were tested for photo-toxicity using the Photo-toxicity-In Vitro 3T3 NRU Photo-toxicity Test” of the Commission Directive 2000/33/EC of 25 Apr. 2000 as published in Official Journal of the European Communities EN. L 136/98 8.6.2000.

A positive result in the in vitro 3T3 NRU photo-toxicity test (PIF≧5 or MPE≧0.1) indicates that the test substance has photo-toxic potential.

A negative result from the in vitro 3T3 NRU photo-toxicity test (PIF<5 or MPE<0.1) indicates that the test substance was not photo-toxic to the cultured mammalian cells under the conditions used.

The photo-bleaches and the results are listed in Table 3 below, PIF values are quoted to 2 significant figures.

TABLE 3

| photo-bleach | PIF | Result |
|---|---|---|
| Chlorpromazine - control | 43 | Photo-toxic |
| 2,4,6-trimethylbenzophenone | 28 | Photo-toxic |
| 2-ethylanthraquinone | >1000 | Photo-toxic |
| 2-sulphate anthraquinone | >170 | |
| Phenylbis(2,4,6- | >12 | Photo-toxic |
| trimethylbenzoyl)-phosphine oxide | | |
| 2,4,6- | >120 | Photo-toxic |
| trimethylbenzoylphenylphosphinic | | |
| acid ester | | |
| 2-hydroxy-4′-hydroxyethoxy-2- | >120 | Photo-toxic |
| methylpropiophenone | | |
| 1-hydroxycyclohexylphenyl ketone | >7.5 | Photo-toxic |
| Vitamin K3 | 2.3 | Non-photo-toxic |

The photo-toxicity experiments were repeated twice more for vitamin K3. PIF values of 1.9 and 1.6 were obtained confirming vitamin K3 as non-photo-toxic.

1. A method of bleaching a textile comprising the steps of treating a textile with a bleaching composition, the bleaching composition comprising vitamin K3 together with at least 1 wt % an ingredient selected from the group consisting of: fabric conditioning agent; and, surfactant, in an aqueous medium followed by irradiating the treated textile.

2. A method of bleaching a textile according to claim 1, wherein the bleaching composition comprises between 2 to 60 wt % of a surfactant.

3. A method of beaching a textile according to claim 1, wherein the composition comprises at least 5 wt % of a fabric conditioner.

4. A method of bleaching a textile according to claim 1, wherein the bleaching composition comprises a builder material.

5. A bleaching composition according to claim 4, wherein the bleaching composition comprises at least 2% sodium carbonate.
